(19) United States
(12) Patent Application Publication
(10) Pub. No.: US 2009/0128307 A1
(43) Pub. Date: May 21, 2009

(54) DISPLAY DEVICE AND DISPLAY METHOD FOR A VEHICLE

(75) Inventors: Norbert Hentsch, Stuttgart (DE); Michael Kokes, Schriesheim (DE); Ralf Ludwig, Stuttgart (DE); Markus Mattedi, Walddorfhaeslach (DE); Bernd Oeffinger, Fellbach (DE); Hannes Weberbauer, Stuttgart (DE); Maik Ziegler, Tiefenbronn (DE)

Correspondence Address: PATENT CENTRAL LLC;Stephan A. Pendorf, 1401 Hollywood Boulevard, Hollywood, FL, 33020, US

(73) Assignee: DaimlerChrysler AG, 70567 Stuttgart (DE)

(21) Appl. No.: 11/575,402

(22) PCT Filed: Sep. 13, 2005
(86) PCT No.: PCT/EP05/09817

§ 371 Date: Jan. 23, 2009

(30) Foreign Application Priority Data
Sep. 16, 2004 (EP) 04022007.1
Jan. 22, 2005 (DE) 10 2005 003 071.8

(51) Int. Cl. B60Q 1/00

(52) U.S. Cl. 340/425.5

(57) ABSTRACT

The invention relates to a display device for a vehicle comprising a display for representing application data to a vehicle user and pivoting means for moving the display between at least two positions. The inventive display device is characterized in that it further comprises checking means for checking whether or not the representation of data of an application selected by the vehicle user is permitted in the actual state of the vehicle; release means in order to release the pivoting means for controlling the display according to the application or any application selected by the vehicle user, in case the checking means emits an affirmative signal.

The invention concerns a display device for a vehicle according to the precharacterizing portion of claim 1 as well as a display method for a vehicle according to the precharacterizing portion of claim 20.

DE 199 38 690 A1 discloses a monitor, which is deployed by the vehicle operator via an associated control element or automatically upon starting of the vehicle.

DE 41 28 663 describes a display device for displaying and for calling up vehicle related information, with a monitor or video display unit which is automatically moveable between two positions. For showing warning information the display is moved to the second position, this movement being used to attract the attention of the vehicle operator.

Representative of this genus of display device is US 2003/0128103 A1 which describes a vehicular display device for display of data for applications such as, for example, video data, and includes a means for moving the display between positions. The disadvantage of this known state of the art device is however that the vehicle user must operate special control elements in order to move the display between the different positions. Further, there is the problem that the display can be moved by the vehicle operator into a position that would impede the vehicle operator's view of the street and therewith impair vehicle operating safety.

It is the task of the present invention to overcome the above mentioned problems.

In accordance with the invention it is provided that the display device further comprises checking means for checking whether or not the representation of data for an application selected by the vehicle user is permitted in the actual operating state of the vehicle, as well as release means in order to release rotation means for controlling the display according to the one or more applications selected by the vehicle user, so long as the checking means provides an affirmative signal. Herein the “vehicle user” refers in particular, however not exclusively, to the vehicle driver.

Expressed another way, the vehicle user need not operate any special operating element in order to release the pivot means for movement of the display (location or orientation change by a movement such as for example rotating or swiveling), which increases comfort. Further, the display is not continuously in the field of vision of the vehicle user—or, as the case may be, suddenly in his field of vision upon starting of the vehicle and without a concrete manual input by the vehicle user—which increases vehicle safety. Rather, the vehicle user selects in normal manner a desired application in that he activates for example a rear view application or a DVD-player device. The selected application then automatically interfaces with the checking means for checking whether the display of data for this application, for example video data, is permissible on the display under the current conditions. Only in this case will the pivot means be correspondingly released by the release means; in other cases, no corresponding release occurs.

The advantage of the invention lies in the increased operating comfort, in that the vehicle user need not actuate any special operating element for displaying the data, rather essentially in convention manner this is selected for him in the vehicle by the operator selected application. Further, the vehicle operating safety is ensured in every situation, in that neither the attentiveness nor the field of vision of the vehicle operator onto the street is impeded; rather, a movement of the display can only then occur when no compromise of the vehicle safety results therefrom. Thereby, that only one display need be employed for representation of data for different vehicle systems, a cost and space savings results, as well as a bundling of information to be displayed at one location in the vehicle.

In a particularly preferred embodiment of the invention a display is provided, which enables a comfortable watching of television or, as the case may be, movie images in a vehicle. Such a “homelike” entertainment is particularly dependent upon a large-format display. However a display of this type for watching television or, as the case may be, movie images in a suitable position (in “deployed” condition) poses a risk for vehicle safety. Namely, in the deployed condition the display impedes the view of the vehicle operator onto the street. Thus, it is provided, that prior to the deployment of the display for displaying television or, as the case may be, movie data, it is first checked whether the vehicle is in a stationary condition. Only in this case is the display depolyable to a suitable position for watching television or movie data.

Stationary can in this sense also mean that the vehicle is stationary without the motor being turned off. It is often the case in utility vehicles that during operation a motor is running in order to supply power to various pieces of equipment. Further, taking into consideration applicable safety regulations, a display of television or movie data on a display might sometimes also be intended, when the vehicle is not stationary. For this, for example, the display is moved not into the deployed position, but rather into a position, in which it provides no impediment for the vehicle operator, for example, in that the display is presented essentially only for a passenger.

In particular, when the vehicle is a commercial or utility vehicle, that is, has a relatively large cabin space, large format displays, that is, those with large screen diagonal measurements, are possible. One rule of approximation for determining a suitable screen diagonal measurement provides that the screen diagonal value should be selected to be one third of the distance between the observer and the display. In a conventional utility vehicle cabin then a display with a screen diagonal of approximately 23 inches would be appropriate. A large format display of this type in the deployed condition, that is, when in a position suitable for “homelike entertainment”, would massively impede the view of the vehicle operator onto the road and therewith the vehicle safety. This is reliably prevented by the present invention.

In accordance with the invention basically both application specific as well as vehicle operating condition dependent movement of the display is possible. In addition, for use of the display for (“homelike-entertainment”) in the deployed condition, one or more further positions of the display can be provided for. In each case, at least one additional “driving position” can be provided as the standard position when the vehicle is moving. In this traveling position of the display in particular a impediment of view for the vehicle operator is precluded and thus the operating safety is ensured. In the travel position it can be provided that the display is not viewable by the vehicle operator, for example by the substantially complete retraction of the display into the dashboard (“retracted position”). This allows a particularly traffic-safe and also optically-appropriate solution. A further possibility is to have an only partially deployed display as the travel position, that is, only a part of the display is visible. In this manner there can be displayed for example data for driver assist systems. Further, it can intended, that a switching between the different travel positions of the display is possible, for example in the environment of a repair station via a diagnostic interface.

Driver assist systems such as, for example, a night vision device, a rear view camera or a navigation system, do not require a large display such as, for example, “homelike entertainment”. Thus for presenting the data of driver assist systems the display is provided, for example, in a position, in which the height corresponds to a relatively small diagonal, for example, at which 7 inches is visible. This display height is in conventional manner sufficient for representing the data of driver assist system. Therein there is the advantage that a large display, for example, a display with a diagonal of 23 inches, therein, that even in a position in which the height of the display exhibits a diagonal of 7 inches, it is still substantially broader than a conventional display of 7 inches. This makes it possible, for example, to simultaneously display the data of multiple driver assist systems on the partially deployed display. Thus the vehicle operator could simultaneously use the navigation system and automatic traffic sign recognition and is thus informed particularly well. Alternatively, or in addition, it is envisioned to provide applications which can take advantage of a larger display surface, for example, night vision devices by a higher image resolution, to provide the corresponding display surface by appropriate positioning of the display and thus to further improve the display for the vehicle operator.

In another embodiment various national traffic regulations concerning the field of view of the vehicle operator can be automatically adapted to, in that, for example, upon GPS recognition of boundary crossing a corresponding automatic position movement of the display is programmed.

The possibility of the presentation of various heights makes it possible to provide space-saving display possibilities. In each case only so much space is occupied, for example, on the dash board, as is necessary for that application. The field of view of the vehicle operator is always unimpeded since the display respectively only is deployed to the extent necessary for the presentation of the data.

Preferably the pivot means of the display is in the form of a housing. Therewith a particularly simple mode of construction can be realized.

A preferred environment of the invention envisions that pivot means are provided for manual movement of the display. If the test means has determined that the display of data of the application selected by the vehicle user is permissible in the actual vehicle condition of operation, then the releasing means release the pivot means in such a manner that the vehicle user can manually position the display via the pivot means into a desired position. If the checking means do not provide an appropriate signal, then a corresponding movement is prevented, for example by an appropriate blocking of the pivot means. Further, the movement of the display could also occur via appropriate actuating elements, such that the movement of the display can occur by motor by actuation of control elements by the vehicle user. Here also an appropriate movement of the display is however only permitted when the checking means has provided the appropriate signal; otherwise, a corresponding movement of the display by actuating the control or operating elements is not possible. Alternatively or supplementally, a further preferred embodiment envisions that the pivot means is designed for an automatic repositioning of the display. This means, that after the checking means has detected that the display of data for an application selected by the vehicle user is permissible in the actual operating condition of the vehicle, the releasing means automatically controls the pivot means in such a manner that the display is brought into an appropriate position. For this, for example, electric, hydraulic, piezo-electric or other means are provided.

One advantageous further development envisions that when the vehicle condition is changed such that a selected application is no longer permissible, the releasing means control the pivot means in such a manner that the display of the data of the actual application on the display is stopped and the pivot means automatically repositions the display into a secured or stowed position. This means, for example, that when the vehicle operator, who is at one point watching a television image, suddenly accelerates to maneuver into a parking place, the display is automatically moved to the extent that the vehicle operator has a free field of view and at the same time the display of data is interrupted.

It is advantageous to provide for various positions of the display, such that for example, with different vehicle speeds the display is automatically repositioned to the extent that, depending upon the speed, an appropriate field of view is provided to the vehicle operator.

In a preferred embodiment it is envisioned that the pivot means is designed for lateral displacement and/or tilting and/or rotating the display. In particular, in the case of manual repositioning of the display, a free positioning of the display into any position desired by the vehicle user allows the user to view the display in the position he would like to have it.

Preferably, control elements are provided on and/or beside the display, such that the vehicle operator can, in the advantageous position of the display, in simple manner operate the control elements. These could be, for example, control elements for contrast, brightness, program selection or the like.

In one preferred embodiment it is envisioned that at least one position of the pivot means and display is provided in the area of the dashboard. The dashboard is a centrally located area in the vehicle familiar to the vehicle user as a possible position of control and/or display elements. Herein various versions are conceivable, for example, a lowering of the display into the dashboard in such a manner that the display is moved from the dashboard upwards into the field of view of the vehicle user. Another possibility is comprised therein, of providing the display horizontally in the dashboard and in the case that it is to be used, it is slid forwards and then rotated in such a manner that the display can be seen by the vehicle user. The results in each case a simple possibility, to recess the display in the dashboard in the case that it is not to be used or only partially used. This provides a space saving and optically appealing solution.

A further preferred embodiment envisions that at least one position of the pivot means and display is provided in the area of the ceiling of the vehicle. The vehicle ceiling is area in which relatively few control elements are provided. There is thus sufficient place for “stowing away” pivot means and the display. If the display is to be used, then it is pivoted down into the field of view of the vehicle user. If it is not to be used then it does not impede the field of view of the vehicle user.

In one particularly preferred embodiment, it is provided that the pivot means is designed in such a manner that the display can be moved into the area of the steering wheel and that in addition an input keyboard associated with the display is likewise moveable into the area of the steering wheel. The results thus a computer workplace for a vehicle user, in particular for surfing on the internet, for taking care of scheduling tasks or for checking email. For this, both an automatic movement as well as a manual movement is possible. It is advantageous to move the display automatically into the area of the steeling and then to allow a manual “fine adjustment” in such a manner that the display can be brought by the vehicle user into a position which is comfortable. The input keyboard can then be taken either by the vehicle user himself, for example from a storage area, and secured to the steering wheel, or it can be provided that the keyboard is automatically moved into the position of the steering wheel. for example, out of the dashboard or out of the driver's door. As input keyboard any input means can be provided, for example, a normal computer keyboard, a flat sheet key entry pad or the like.

In summary the invention makes it possible to advantageously bundle the various vehicle user display requirements. The display of data of an increasing number of vehicle operator assist systems as well as likewise increasing presence of “homelike” entertainment functions are bundled into one display particularly simply in accordance with the invention. Therein the vehicle user need not concern himself with an appropriate positioning of the display depending upon the respective data to be displayed. Rather, he selects essentially in conventional manner a desired application. At the same time it is ensured in any situation that the vehicle operator is continuously in compliance with the actual traffic regulations and requirements with respect to vehicle safety. This, because the appropriate display is only allowed in accordance with corresponding safety requirements. Here advantageous further developments are also conceivable, for example, a simple adaptation to various viewing requirements by appropriate programming of the release means or an automatic pivoting of the display upon bringing the vehicle into motion. If for example, the vehicle operator watches television images in a traffic jam and suddenly must drive, then the display automatically moves into a position in which the vehicle operator's view is not compromised.

Further, there results a saving of construction space, in that only one single display need be used upon which a wide variety of display tasks can be presented. It is simply pivoted to present the size necessary for the actual display tasks.

It is advantageous that the field of view of the operator is not compromised by a large display during driving; the functionality, however, is used in sufficient measure. During a rest phase the entire image screen is accessible for entertainment or computing. Finally it can thereby be avoided that one small and one large display need be incorporated. Therewith savings in cost and space in the cockpit can be realized.

The invention will not be described in greater detail on the basis of the figures. There are shown in:

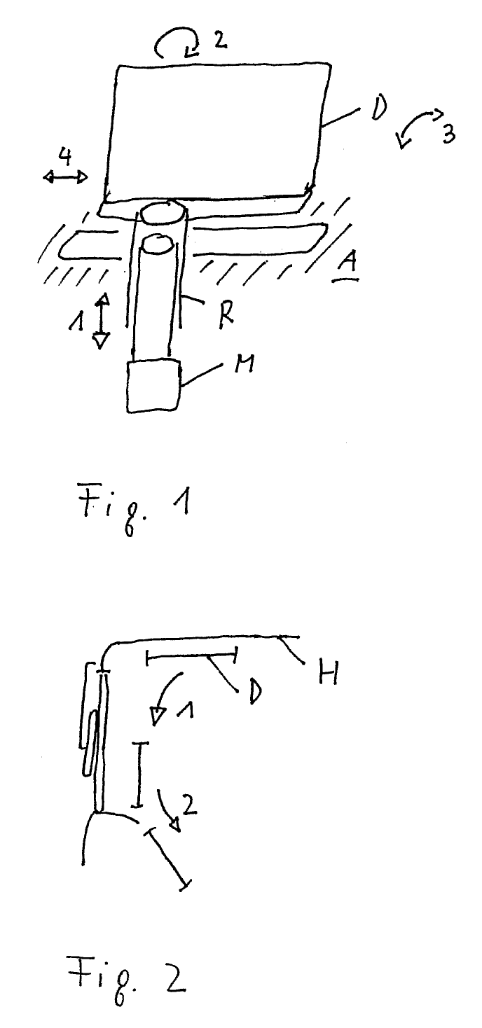

FIG. 1 a first embodiment of the invention,

FIG. 2 a second embodiment of the invention,

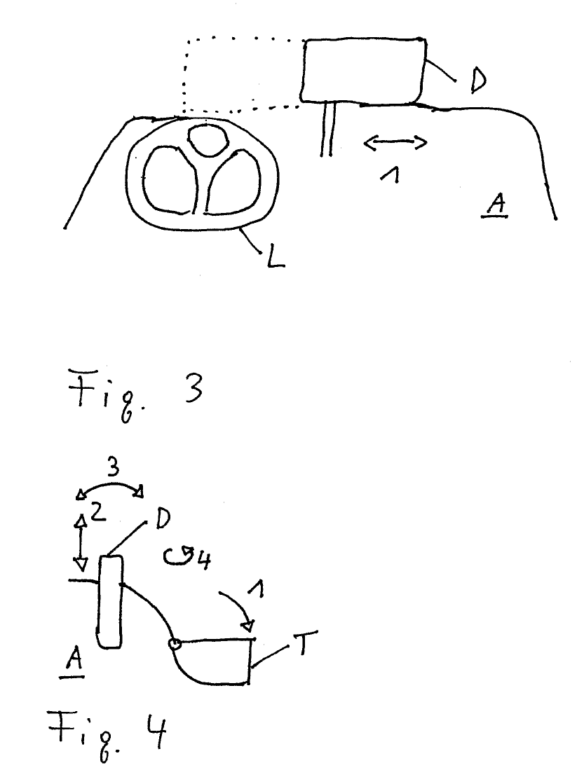

FIG. 3 a third embodiment of the invention,

FIG. 4 a fourth embodiment of the invention

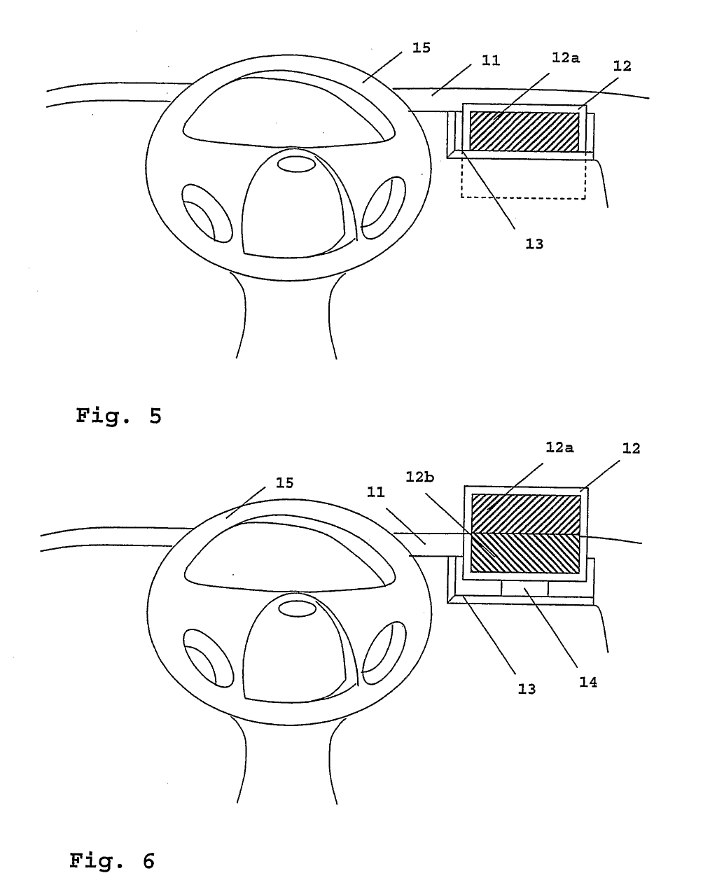

FIG. 5 a view of a fifth embodiment of the invention during vehicle motion,

FIG. 6 a view of a fifth embodiment of the invention in a resting phase, and

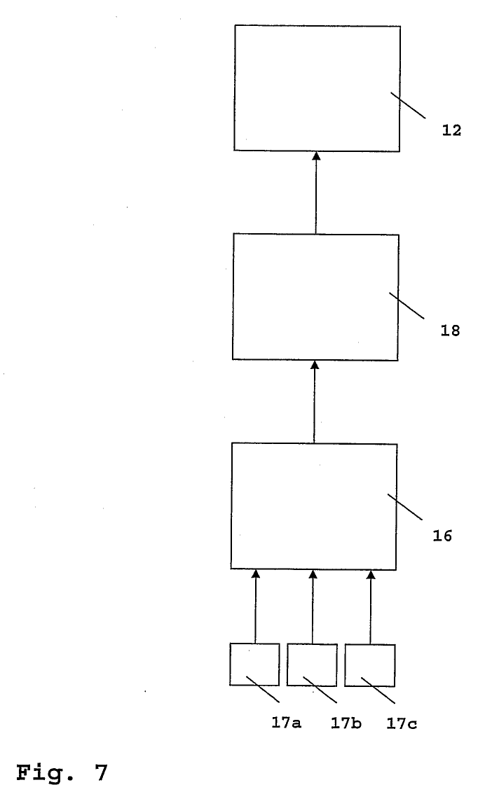

FIG. 7 a block diagram of the fifth embodiment of the invention.

FIG. 1 shows one possibility of providing the display D in the area of the dashboard A. In this special embodiment a tube R is provided, on which the display D can be moved in automated manner vertically 1 (towards upwards or, as the case may be, downwards) by a motor M. Further, the display D is rotatable 2 about the tube R as well as tiltable 3 and pivotable 4 to the left and to the right, in order to provide a comfortable and secure viewing of the data displayed in the display D.

FIG. 2 shows the display D which is pivoted down 1 from the vehicle ceiling H and then appropriately tiltable 2 in order to provide the vehicle operator a comfortable and secure view onto the data displayed on the display D.

FIG. 3, finally, shows a possibility, as a further development of the embodiment according to FIG. 1, that the display D “deployed” out of the dashboard A is moved laterally 1 into the area of the steering wheel L. Thus, a computer keyboard can be provided on the steering wheel. Therewith a computer workplace results for the vehicle operator, for example, for taking care of scheduling tasks.

FIG. 4 shows a further embodiment of the invention in the area of the dashboard A. Therein it is envisioned that a part T of the dashboard A can be folded forwards or downwards in order to make the display D partially or completely visible to the vehicle user. The folding down 1 can occur therein automatically as well as manually. Sensors could be provided for checking whether a safe folding down is possible. Therein the display D is vertically movable after the folding down 1, and is tiltable 3 and rotatable 4 in order to provide the vehicle operator with a comfortable and safe viewing of the data displayed on the display D. In the not folded down condition the display D is either not visible or is only partially visible for the vehicle user.

With reference to FIGS. 5-7, the precise sequence of operation of a fifth embodiment of the invention is described which in the following will be referred to as “inventive display device”.

In FIGS. 5-7 the same elements are referenced with the same reference numbers.

In FIGS. 5 and 6 reference number 11 indicates a dashboard of a vehicle, 12 a display device with a first partial display area 12a and a second partial display area 12b, 13 a slit in which the display device 12 is vertically or laterally movable or sinkable, as well as 14 a mount for the display device 12 via which a rotation as well as a pivoting of the display device 12 about its axis is possible and 15 a steering wheel, which is provided adjacent to the display device 12.

In addition to this, as shown in the block diagram of the inventive display device according to FIG. 7, a deployment device 18 is provided, which serves for deploying the display device 12 in response to a manual operation of a (not shown) deployment activation device or in response to an automatic generated deployment signal.

For producing the automatically generated deployment signal for the deployment device 18 the inventive display device includes an analysis device 16, which receives as input signals automotive specific parameters such as, for example, RPM, gear, ignition position, etc., from appropriate detection devices 17a, 17b, 17c, . . . . The analysis device determines on the basis of these input signals whether a driving is occurring or whether the vehicle has been stopped, that is, whether it is currently in a rest phase. Depending upon the determined results, the analysis device 16 provides a control signal to the deployment device 18 for the display device 12, which in the case of driving operation is partially deployed as appropriate to the display device 12, so that only the first partial display area 12a is available, while in the case that the vehicle is stationary the display device 12 is completely deployed and thus the mount 14 is set to be free over multiple degrees with respect to the driver and thus the first partial display area 12a as well as the second partial display area 12b is visible. It can be particularly advantageous when it is designed that the display device 12 can be rotated and pivoted about the axis of the mount 14 only when the first and the second partial display areas 12a, 12b are deployed. If only the first partial display area 12a is deployed, then the display device 12 is embedded in the dashboard 11, so that it does not project beyond the upper surface of the dashboard 11 and thus the view of the driver is not impaired.

In addition, the safety function of the blocking device 19 can be designed so that either the input signals of the analysis device 16 for determining a driving condition or the output signal of the analysis device 16 are supplied and in the case of a vehicle operation or movement a deployment of the display device 12 beyond a first partial display area 12a is mechanically or electrically blocked by the deployment device 18. In this manner a complete deployment of the display device 12 during vehicle operation, and thus a covering of part of the important field of view onto the street, can be reliably prevented.

In this manner it can be ensured with the inventive display device that the driver can easily read the display device and at the same time uses only the necessary partial area of the display device and thereby areas of the field of view onto the street are not unnecessarily obstructed.

1. A display device for a vehicle, including a display (D), for displaying data for applications for a vehicle user, and means (R, 14) for moving the display between at least two positions, wherein that the display device further includes:
checking means, for checking whether the display of data of an application selected by the vehicle user is permissible in the actual condition of operation of the vehicle, as well as
release mean, for release of the means for moving and for controlling the display according to the one of more applications selected by the vehicle user, in the case that the checking means provide a positive signal.

2. The display device according to claim 1, wherein the means for moving include the housing of the display.

3. The display device according to claim 1, wherein the means for moving are designed to allow a manual movement of the display.

4. The display device according to claim 1, wherein the means for moving are designed for an automated movement of the display.

5. The display device according to claim 1, wherein the means for moving are designed for sliding and/or tilting and/or rotating the display.

6. The display device according to claim 1, wherein control elements are provided on or beside the display.

7. The display device according to claim 1, wherein the application is the presentation of data for a driver assist system.

8. The display device according to claim 1, wherein the vehicle is a commercial vehicle and the display has a diagonal of approximately 23 inches.

9. The display device according to claim 1, wherein the application is the display of television or, as the case may be, movie data on the display.

10. The display device according to claim 9, wherein the checking means approves the display of television or, as the case may be, movie data on the display only when the vehicle is stationary.

11. The display device according to claim 1, wherein at least one position of the means for moving and of the display is provided in the area of the dashboard.

12. The display device according to claim 11, wherein the display is at least partially submersible into the dashboard.

13. The display device according to claim 1, wherein the display device (12) includes a first and a second partial display area (12a, 12b) and is secured to a mount (14), through which the rotation as well as the pivoting of the display device (12) about its axis is Possible, wherein the display device (12) can pass vertically or sideways into a slit (13) in the dashboard (11),
wherein an analysis device (16) receives as input signals automotive specific parameters from detection devices (17a, 17b, 17c), which analysis device (16) determines on the basis of these input signals whether a mobile or a stationary condition exists, and which provides a control signal to the deployment device (18) for the display device (12) to which signal the deployment of the display device (12) is responsive, wherein the display device (12) is only deployed to the first partial display area (12a) during a mobile phase and the first and second partial display areas (12a, 12b) are deployed during the stationary phase.

14. The display device according to claim 13, including a blocking device (19) to which the control signal of the analysis device (16) is supplied and which, in response to a control signal indicating a mobile condition of the vehicle, mechanically or electronically blocks the deployment of the display device (12) by the deployment device (18) beyond the first partial display area (12a).

15. The display device according to claim 13, wherein the deployment device (18) for the display device (12), besides being capable of an automated activation responsive to the control signal, is also manually operable via a deployment activation device.

16. The display device according to claim 13, wherein the display (12) is rotatable and pivotable about the axis of the mount (14) only when the first and the second partial display areas (12a) are deployed.

17. The display device according to claim 13, wherein the display device (12), when the first partial display area (12a) is deployed, is so integrated into the dashboard (11), that it does not project above the upper surface of the dashboard (11) and does not impede the view of the driver.

18. The display device according to claim 1, wherein at least one position of the pivot means and display is provided in the area of the vehicle ceiling.

19. The display device according to claim 1, wherein the pivot means is designed for a movement of the display into the area of the steering wheel, and wherein in addition a display-associated input keyboard can be moved into the area of the steering wheel.

20. (canceled)

21. A process for display of data of applications for a vehicle user, wherein the data are presented upon a display, which is moveable between at least two positions via means for moving the display between at least two positions, the process comprising:
selecting an application for which data is to be displayed.
checking, via means for checking whether the display of data of an application selected by the vehicle user is permissible in the actual condition of operation of the vehicle, whether the display of data of this selected application is permissible in the actual condition of operation of the vehicle, and in the case of a positive result of the checking,
releasing means for moving the display between at least two positions, and operating the display according to the one or more applications selected by the vehicle user.
